(19) United States
(12) Patent Application Publication
(10) Pub. No.: US 2022/0176564 A1
(43) Pub. Date: Jun. 9, 2022

(54) ACCURATE POSITION CONTROL FOR FIXTURELESS ASSEMBLY

(71) Applicant: GM GLOBAL TECHNOLOGY OPERATIONS LLC, Detroit, MI (US)

(72) Inventors: Miguel A. Saez, Clarkston, MI (US); John P. Spicer, Plymouth, MI (US); James W. Wells, ROCHESTER HILLS (US)

(21) Appl. No.: 17/111,739

(22) Filed: Dec. 4, 2020

(51) Int. Cl. B25J 9/16; B25J 11/00; B25J 13/00; B25J 13/08

(52) U.S. Cl. CPC B25J 9/1697; B25J 9/163; B25J 9/1653; B25J 13/089; B25J 11/005; B25J 13/006; B25J 13/085; B25J 9/1679

(57) ABSTRACT

A part manufacturing system and a method of manufacturing are provided. The system includes one or more part-moving robots, each having an end effector that grips a part. An operation robot performs an operation on the part while the part-moving robot holds the part. A fixed vision system is located apart from the robots and has at least one fixed vision sensor that senses an absolute location of the part and/or the end effector and generates a fixed vision signal representative of the absolute location. A controller collects the fixed vision signal and compares the absolute location with a predetermined desired location of the part and/or the end effector. The controller sends a repositioning signal to the part-moving robot if the absolute location varies from the predetermined desired location by at least a predetermined threshold, and the part-moving robot is configured to move the part upon receiving the repositioning signal.

### INTRODUCTION

The present disclosure relates to a manufacturing system including a vision system for accurately positioning parts.

A typical automotive manufacturing plant includes fixtures for assembling parts together, to provide a structure onto which joining operations may be performed. However, modernly, fixtureless assembly systems are gaining popularity because they provide for much greater flexibility to manage dynamic volumes and types of vehicles or vehicle parts being assembled. Fixtureless assembly systems include robots that move parts and join the parts together without using stationary fixtures to position the parts.

While they have many benefits, fixtureless assembly systems are challenging because it is difficult to accurately position the parts without a stationary fixture.

### SUMMARY

The present disclosure provides a manufacturing system and method that uses a remote vision system located apart from the part-moving, part handling, robots. The remote vision system provides an accurate absolute position of the robot end effectors and/or the parts, which allows for an operation, such as a joining operation, to be performed accurately on the parts.

In one form, the present disclosure provides a part assembly system that includes a first robot having a first end effector configured to grip a first part and to move the first part, and a second robot having a second end effector configured to grip a second part and to move the second part. A third robot is configured to perform an operation on the first and second parts, and the first and second robots are configured to hold the first and second parts while the third robot performs the operation. A remote vision system is located apart from the first, second, and third robots. The remote vision system has at least one vision sensor configured to sense a first absolute location of the first part and/or the first end effector and to generate a first vision signal representative of the first absolute location. One or more vision sensors are also configured to sense a second absolute location of the second part and/or the second end effector and to generate a second vision signal representative of the second absolute location. A controller is configured to collect the first vision signal and the second vision signal, and the controller is further configured to compare the first absolute location with a first predetermined desired location of the first part and/or the first end effector. The controller is configured to send a first repositioning signal to the first robot if the first absolute location varies from the first predetermined desired location by at least a first threshold. The controller is further configured to compare the second absolute location with a second predetermined desired location of the second part and/or the second end effector, and the controller is configured to send a second repositioning signal to the second robot if the second absolute location varies from the second predetermined desired location by at least a second threshold. The first robot is configured to move the first part upon receiving the first repositioning signal, and the second robot is configured to move the second part upon receiving the second repositioning signal.

In another form, which may be combined with or separate from the other forms disclosed herein, a method of performing a manufacturing operation is provided. The method includes moving a part to a relative position via an end effector on a robot based on a vision signal generated by a vision sensor located on a movable part of the robot. The method also includes sensing an absolute location of the part and/or the end effector via at least one vision sensor of a remote vision system located apart from the robot and the end effector. The method includes generating a remote vision signal representative of the absolute location and comparing the absolute location with a predetermined desired location of the part and/or the end effector. The method further includes repositioning the end effector and the part if the absolute location varies from the predetermined desired location by at least a threshold until the absolute location is within the threshold of the predetermined desired location. The method includes performing an operation on the part when the absolute location is within the threshold of the predetermined desired location.

In yet another form, which may be combined with or separate from the other forms contained herein, a part manufacturing system is provided that includes a part-moving robot having an end effector configured to grip a part and to move the part, and an operation robot configured to perform an operation on the part. The part-moving robot is configured to hold the part while the operation robot performs the operation. A remote vision system is located apart from the robots. The remote vision system has at least one vision sensor configured to sense an absolute location of the part and/or the end effector and to generate a remote vision signal representative of the absolute location. A controller is configured to collect the remote vision signal, and the controller is further configured to compare the absolute location with a predetermined desired location of the part and/or the end effector. The controller is configured to send a repositioning signal to the part-moving robot if the absolute location varies from the predetermined desired location by at least a predetermined threshold. The part-moving robot is configured to move the part upon receiving the repositioning signal.

In still another form, which may be combined with or separate from the other forms disclosed herein, a manufacturing system is provided that includes an operation robot having a tool configured to perform an operation on a part and a remote vision system located apart from the operation robot. The remote vision system has at least one vision sensor configured to sense an absolute location of the tool and to generate a vision signal representative of the absolute location. A controller is configured to collect the vision signal, and the controller is configured to compare the absolute location with a predetermined desired location of the tool. The controller is configured to send a repositioning signal to the operation robot if the absolute location varies from the predetermined desired location by at least a predetermined threshold, and the operation robot is configured to move the tool upon receiving the repositioning signal.

Additional features may optionally be provided, including but not limited to the following: the remote vision system comprising a remote end effector vision system; the at least one vision sensor being part of the remote end effector vision system and including at least one photogrammetry sensor configured to determine the first absolute position and the second absolute position, the first absolute position being a position of the first end effector, and the second absolute position being a position of the second end effector; the remote vision system comprising a remote part vision system configured to determine a part location of each of the first and second parts based on at least one feature on each of the first and second parts; the remote part vision system including a laser radar sensor configured to determine a datum position of at least one of the features; wherein the controller includes a control logic configured to define a shared coordinate system between the first vision sensor, the second vision sensor, and the at least one remote vision sensor to define the first and second absolute locations and the first and second predetermined desired locations on the shared coordinate system; the third robot being configured to perform a welding operation on the first and second parts to join the first and second parts together; the first and second end effectors being configured to hold the first and second parts in contact with one another while the third robot performs the welding operation; the first robot having a first local vision sensor located on a movable portion of the first robot and configured to sense a relative location of the first part and generate a first robot vision signal representative of the relative location of the first part; the second robot having a second local vision sensor located on a movable portion of the second robot and configured to sense a relative location of the second part and generate a second robot vision signal representative of the relative location of the second part; the first robot further having a first force sensor configured to sense force between the first part and the second part; the remote vision system comprising a remote end effector vision system configured to determine the absolute location; the absolute location being a location of the end effector; and/or the remote vision system further comprising a remote part vision system including a laser radar sensor and being configured to determine a part location of the part based on at least one feature on the part.

Further additional features may optionally be provided, including but not limited to the following: the step of sensing the absolution location of one of the part and the end effector including sensing the absolute location of the end effector; sensing a part feature on the part via a remote part vision system after the step of performing the operation; determining a part location based on the part feature; the step of sensing the part feature including using laser radar to sense the part feature; defining a shared coordinate system for comparing the relative position of the part, the absolute location of the end effector, the predetermined desired location of the end effector, and the part location; moving a second part to a second relative position via a second end effector on a second robot based on a vision signal generated by a vision sensor located on the second end effector; sensing a second absolute location of the second end effector via the at least one remote vision sensor, the at least one remote vision sensor being located apart from the second robot and the second end effector; generating a second remote vision signal representative of the second absolute location; comparing the second absolute location with a second predetermined desired location of the second end effector; repositioning the second part to the second predetermined desired location if the second absolute location varies from the second predetermined desired location by at least a second threshold, wherein the step of performing the operation on the first part when the first part is located at the first predetermined desired location includes performing a welding operation on the first and second parts to join the first and second parts together; holding the first and second parts in contact with one another while performing the welding operation; sensing a force between the first part and the second part to assist in moving the first part to the first relative position; wherein the step of sensing the part feature is performed after the step of moving the first part to the first relative position based on the vision signal generated by the vision sensor; and scanning the part feature prior to the step of moving the first part to the first relative position to determine an initial position of the part.

Further aspects, advantages and areas of applicability will become apparent from the description provided herein. It should be understood that the description and specific examples and drawings are intended for purposes of illustration only and are not intended to limit the scope of the present disclosure.

### BRIEF DESCRIPTION OF THE DRAWINGS

FIG. 1 is a schematic perspective view of an example assembly system for assembling manufactured items, in accordance with the principles of the present disclosure;

FIG. 2 is a schematic perspective view of another example assembly system for assembling manufactured items, according to the principles of the present disclosure;

FIG. 3 is a block diagram illustrating a method for performing a manufacturing operation, according to the principles of the present disclosure; and

FIG. 4 is a block diagram illustrating another method for performing a manufacturing operation, according to the principles of the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The drawings are in simplified schematic form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

The following description is merely exemplary in nature and is not intended to limit the present disclosure, application, or uses.

The present disclosure provides a system and method that monitors the position of an end effector and/or a part from a remote location, as part of a fixtureless assembly system and uses the remote position information to accurately reposition the part if needed.

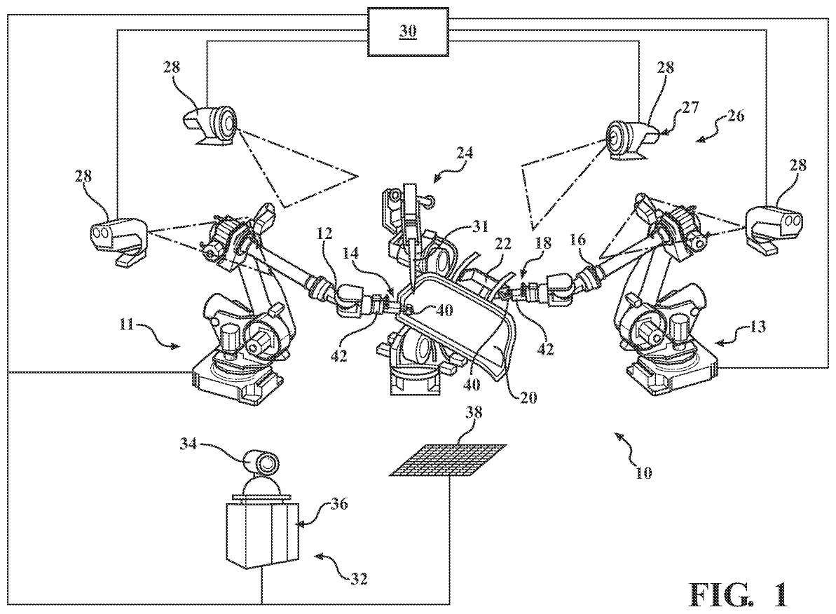

Referring to FIG. 1, a fixtureless component assembly system of the present disclosure is shown generally at 10. The component assembly system 10 comprises a first robot 11 having a first robot arm 12 with a first end-of-arm tool 14 mounted thereon, where the end-of-arm tool 14 may be referred to as an end effector. The component assembly system 10 further comprises a second robot 13 having a second robot arm 16 with a second end-of-arm tool or end effector 18 mounted thereon. The first end effector 14 is adapted to grasp a first subcomponent 20 and hold the first subcomponent 20 during the assembly process. The second end effector 18 is adapted to grasp a second subcomponent 22 and hold the second subcomponent 22 during the assembly process. Though two robots 11, 13 are shown to hold the subcomponents 20, 22, any number of additional robots could be included to hold additional components or subcomponents or to aid in holding one of the subcomponents 20, 22 illustrated. In the alternative, a single robot may be used to hold a part onto which an operation may be performed, without falling beyond the spirit and scope of the present disclosure.

As an alternative to using robots 11, 13 having arms 12, 16 bearing end effectors 14, 18, the robots 11, 13 could be another type of robot, such as a mobile robot, bearing the end effectors 14, 18. Therefore, as used herein, a robot could be understood to be a type having articulating arms, a mobile robot, a parallel kinematic machine, or another type of robot.

The first subcomponent 20 may be, as a non-limiting example, a panel configured as a decklid, a liftgate, a hood, or a door for an automotive vehicle, a frame, while the other subcomponent 22 may be an attachment, frame, body component, or other subcomponent that is ultimately attached to the first subcomponent 20, such as brackets (e.g., shock tower) on a truck frame. Alternatively, either of the first and second subcomponents 20, 22 may be any number of other desired components, such as an aircraft fuselage panel, a door panel for a consumer appliance, an armrest for a chair, or any other subcomponent configured to be joined or attached to another subcomponent. The first and second subcomponents 20, 22 may be formed from any suitable material, such as, metal, plastic, a composite, and the like.

The first and second robot arms 12, 16 may be programmable mechanical arms that may include hand, wrist, elbow, and shoulder portions, and may be remotely controlled by pneumatics and/or electronics. The first and second robot arms 12, 16 may be, as non-limiting examples, a six-axis articulated robot arm, a Cartesian robot arm, a spherical or polar robot arm, a selective compliance assembly robot arm, a parallel kinematic machine (PKM) robot, and the like.

Thus, the first robot 11 includes the first end effector 14 configured to grip the first part 20 and to move the first part 20. The second robot 13 includes the second end effector 18 configured to grip the second part 22 and to move the second part 22. The first and second robots 11, 13 are part-moving or handling robots configured to pick up and move the first and second parts 20, 22.

A third robot 24, which is an operation-performing robot, is provided to perform an operation, such as a joining operation, on the first and second parts 20, 22. In some cases, the robots 11, 13 move the parts 20, 22 into contact with one another while the third robot 24 performs the joining operation on the first and second parts 20, 22. In other cases, the parts 20, 22 may be merely moved into predetermined positions with respect to one another, but not necessarily in contact with one another, to be joined together. The parts 20, 22 could be interlocked together, such as with special retaining features (not shown) included in each of the parts 20, 22. In such a case, the parts 20, 22 could be interlocked together and then released by the first and second robots 11, 13 prior to the third robot 24 performing the operation (such as spot welding, MIG welding, laser welding, or fastening).

The third robot 24 may be configured to perform resistance spot welding (RSW), gas metal arc welding (GMAW), remote laser welding (RLW), MIG welding, riveting, bolting, press fitting, or adding adhesive and/or clamping the first and second parts 20, 22 together, by way of example. In the alternative, the third robot 24 may perform an operation on the first part 20 alone.

Each or any of the robots 11, 13, 24 may have a local vision system that includes attached, local vision sensors located on the robot arms 12, 16, 31 or on the end effectors 14, 18. For example, the first robot 11 may have a first vision sensor 40 located on a movable portion of the first robot 11, such as on the end effector 14. The local vision sensor 40 is configured to sense a relative location of the first part 20 and to generate a first robot vision signal representative of the relative location of the first part 20. Thus, the robot 11 is vision-guided to move the part 20 to the pre-assembly location for assembly with the second part 22. Likewise, the second robot 13 may have a second local vision sensor 41, which may be identical to the first local vision sensor 40, located on a movable portion of the second robot 13 and configured to sense a relative location of the second part 22 and generate a second robot vision signal representative of the relative location of the second part 22.

A system controller 30 is adapted and configured to control the first and second and robot arms 12, 16 and the end effectors 14, 18. The system controller 30 may be a non-generalized, electronic control device having a preprogrammed digital computer or processor, memory or non-transitory computer readable medium used to store data such as control logic, software applications, instructions, computer code, data, lookup tables, etc., and a transceiver or input/output ports. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

The system controller 30 may be configured to move the first, second and third robot arms 12, 16, 31 and actuate the end effectors 14, 18 to bring the first and second end effectors 14, 18 to a position to grasp the first and second subcomponents 20, 22 and bring the first and second and end effectors 14, 18 into position to properly position the first and second subcomponents 20, 22 relative to each other. Movement of the first and second robot arms 12, 16 by the system controller 30 is based on executable code stored in memory or provide to the system controller 30, by way of example, and may be guided by the vision sensors 40, 41.

The system 10 includes a remote vision system 26 located spaced apart from the first, second, and third robots 11, 13, 24. The remote vision system 26 may include a remote end effector vision system 27 having fixed vision sensors 28, such as cameras, photoreceivers, or photogrammetry sensors. These sensors can use active or passive or reflective targets, which can be installed in the end of arm tools 14, 18, in the robots 11, 13, or in their connecting joints. The vision sensors 28 may be fixed to walls or other stationary structure, or they may be located on a movable device that is located apart from the robots 11, 13, 24.

Preferably, the vision sensors 28 are fixed to stationary structure, such as walls of the room. The vision sensors 28 are configured to sense a first absolute location of the end effectors 14, 18 of the robot arms 12, 16, and/or of the parts 20, 22 in some examples. In this example, the vision sensors 28 are configured to sense the absolute location of the end effectors 14, 18 that hold each of the parts 20, 22. The vision sensor(s) 28 are configured to generate a first remote vision signal representative of the absolute location of the first end effector 14 (the first absolute location) and a second remote vision signal representative of the absolute location of the second end effector 18 (the second absolute location).

The system controller 30 is configured to collect the first remote vision signal and the second remote vision signal, and the controller 30 is further configured to compare the first absolute location with a first predetermined desired location of the first end effector 14 (or in some cases, the first part 20). The controller 30 is configured to send a first repositioning signal to the first robot 11 if the first absolute location varies from the first predetermined desired location by at least a first threshold (a tolerance). The first robot 11 is configured to move the first part 20 upon receiving the first repositioning signal.

Likewise, the controller is further configured to compare the second absolute location with a second predetermined desired location of the second end effector 18 (or in some cases, the second part 22). The controller 30 is further configured to send a second repositioning signal to the second robot 13 if the second absolute location varies from the second predetermined desired location by at least a second threshold. The second robot 13 is configured to move the second part 22 upon receiving the second repositioning signal.

The remote vision system 26 may also or alternatively include a remote part vision system 32 configured to determine a part location of each of the first and second parts 20, 22. The part location may be determined based on at least one part feature, such as a datum feature, on each of the first and second parts 20, 22, or by registering a 3D surface of each part 20, 22, by way of example. The remote part vision system 32 may include a remote laser radar sensor 34 as part of a metrology unit 36, which is configured to determine a datum position (or a feature or edge position) of at least one of the datum features (or other features) on the part(s) 20, 22. In addition, or in the alternative, the remote part vision system 32 may include cameras. The remote part vision system 32 locates interface surfaces, datums, and identifying features on the first and second parts 20, 22 and communicates with the system controller 30.

Like the remote end effector vision system 27, the remote part vision system 32 may include sensors 34 that are fixed to walls or other stationary structure, or the sensors 34 may be located on a movable device that is located apart from the robots 11, 13, 24.

The system controller 30 includes a control logic configured to define a shared coordinate system 38, or shared coordinate frame, between the first attached vision sensor 40, the second attached vision sensor 41, the remote end effector vision sensor(s) 28, and the remote part sensor(s) 34. The shared coordinate system 38 defines the first and second absolute locations and the first and second predetermined desired locations on the shared coordinate system 38. The shared coordinate frame 38, including a shared origin and orientation, can be created using a single or a plurality of 2D or 3D fiducials.

To establish a shared coordinate system 38, a fixed, high-precision, and thermally stable artifact is included that can be viewed/measured by all vision systems (both the remote vision system 26, which may include the remote end effector vision system 27 and the remote part vision system 32, and the local vision system that includes the local vision sensors 40, 41), where the origin (X, Y, Z) and rotations around that origin (roll, pitch, yaw) is identical and shared for all systems. The type of artifact used must be consistent with the type of vision (metrology) system being utilized. For example, for laser radar, the artifact may be a precision tooling ball (sphere); for photogrammetry, the artifact may be three or more LED fiducials arranged on multiple planes on a thermally stable carbon fiber structure; and for a 2D machine vision camera, a 2D calibration grid of circular features (dots) or a checkerboard pattern arranged on flat plane could be used as the artifact. The shared coordinate system 38 could also utilize multiple artifacts of the same (or different) type(s), consistent with one or more vision (metrology) system type(s), where the relative positions of the artifacts are precisely known and thermally stable among the artifacts. For example, three artifacts could be used in a robot cell, potentially of different types (tooling ball, LED fiducials on a thermally stable carbon fiber structure, or 2D calibration grid) where the position and orientation of all of the artifacts is known accurately and the relative position and orientation among them is also known accurately.

Each of the first and second robots 11, 13 may include force gauges 42 mounted on the end effectors 14, 18 that are configured to measure torque forces and lateral forces placed on the subcomponents 20, 22 by the end effectors 14, 18. Thus, the first and second robot arms 12, 16 may be adapted to be controlled by the system controller 30 based either or both of position control (via the vision sensors 40, 41, 28, 34) or force control (via the force sensors 42). When the system controller 30 is using force control, the first and second robot arms 12, 16 are controlled based on the force feedback measured by the force gauges 42. In some examples, portions of the second subcomponent 22 may slide into receiving portions of the first subcomponents 20 in a slip fit engagement. As the first and second subcomponents 20, 22 are engaged, frictional forces of the slip fit engagement are measured by the force gauges 42. The system controller 30 then may use force control and information from the force gauges 42 to move the first and second robot arms 12, 16 and force the first and second subcomponents 20, 22 into slip fit engagement with one another until the first and second subcomponents 20, 22 are fully engaged based on the force measurements. In the alternative to a slip fit, a press fit, loose fit, interference fit, or clearance fit may be used, by way of example.

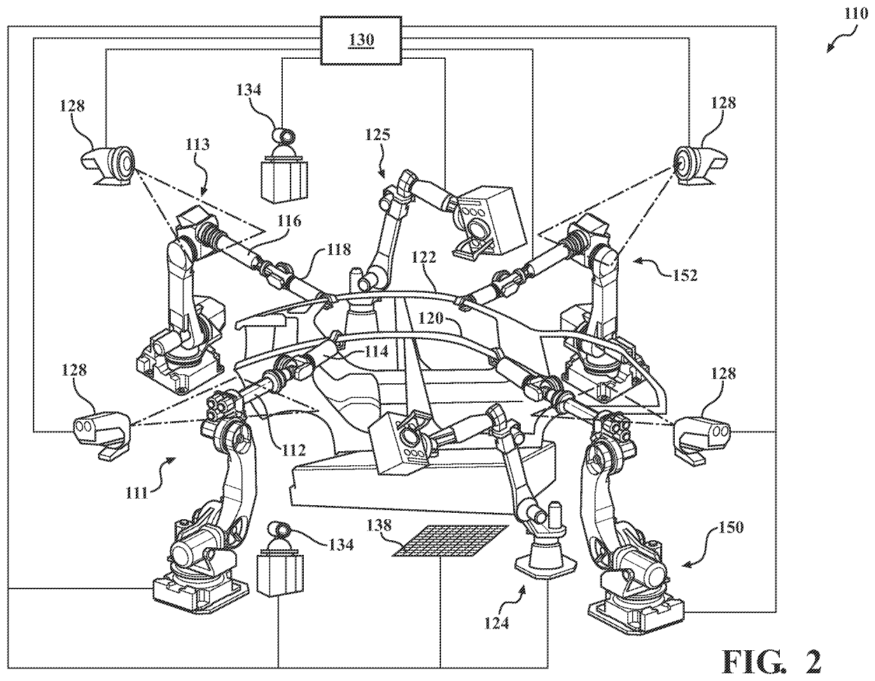

Referring now to FIG. 2, yet another example of a fixtureless assembly system of the present disclosure is shown generally at 110. The fixtureless assembly system 110 differs from the fixtureless assembly system 10 described above in that it is a body assembly system 110 instead of a component assembly system 10. As such, the fixtureless assembly system 110 is configured to assemble vehicle body components 120, 122. Like the component fixtureless assembly system 10, the body assembly system 110 comprises a first robot 111 having a first robot arm 112 with a first end effector 114 mounted thereon, and the body assembly system 110 further comprises a second robot 113 having a second robot arm 116 with a second end effector 118 mounted thereon. Due to the size and/or weight of the body components 120, 122, additional handling or part-moving robots 150, 152 may be provided that have essentially the same parts and features as the first and second robots 111, 113. For example, a third handling robot 150 may assist the first robot 111 in grasping and moving the first body component 120, and a fourth handling robot 152 may assist the second robot 113 in grasping and moving the second body component 122.

As an alternative to using robots 111, 113, 150, 152 having arms 112, 116 bearing end effectors 114, 118, any of the robots 111, 113 could be another type of robot, such as a mobile robot, bearing the end effectors 114, 118. Therefore, as used herein, a robot could be understood to be a type having articulating arms, a mobile robot, a parallel kinematic machine, or another type of robot.

Except for where described as being different, the assembly system 110 may have the same features and components as the assembly system 10 described above. For example, each of the robot arms 112, 116 may be programmable mechanical arms that may include hand, wrist, elbow, and shoulder portions, and may be remotely controlled by pneumatics and/or electronics. A pair of operation robots 124, 125 may be provided to perform operations, such as a joining operations, on the first and second parts 120, 122. In some cases, the robots 111, 113, 150, 152 move the parts 120, 122 into contact with one another and hold the parts 120, 122 in contact with one another while the operation robots 124, 125 perform the joining operation on the first and second parts 120, 122. In other cases, the parts 120, 122 may be merely moved into predetermined positions with respect to one another, but not necessarily in contact with one another, to be joined together.

Like the operation robot 24 described above, the operation robots 124, 125 may be configured to perform resistance spot welding (RSW), gas metal arc welding (GMAW), remote laser welding (RLW), riveting, bolting, press fitting, or adding adhesive and/or clamping the first and second parts 120, 122 together, by way of example.

Each or any of the robots 111, 113, 124, 125, 150, 152 may have attached vision sensor(s) located on its robot arm or end effector. As described above, the attached vision sensors located on the robot arms or end effectors are configured to sense a relative location of each of parts 120, 122 to generate robot vision signal representative of the relative location of the parts 120, 122. Thus, the handling robots 111, 113, 150, 152 may be vision-guided to move the parts 120, 122 to the pre-assembly locations.

A system controller 130 is adapted and configured to control the robots 111, 113, 124, 125, 150, 152 and their associated arms and end effectors, like the system control 30 described above. Initial movement of the robot arms and end effectors of the part handling robots 111, 113, 150, 152 may be based on the attached vision sensors located on the robots 111, 113, 150, 152 and/or force sensors located thereon.

The system 110 includes a remote vision system 126 located spaced apart from the robots 111, 113, 124, 150, 152, which may operate similarly to the remote vision system 26 described above. Thus, photogrammetry sensors 28 fixed to non-movable structure and/or laser sensors 134 may be used to determine absolute locations of the parts 120, 122 and/or the end effectors of the robots 111, 113, 150, 152.

The system controller 130 is configured to collect the remote vision signals from the remote vision system 126 and to compare the absolute locations of the end effectors and/or the parts 120, 122 with predetermined desired locations of the end effectors and/or the parts 120, 122. The controller 130 is configured to send repositioning signals to any of the handling robots 111, 113, 150, 152 if the absolute locations vary from the predetermined desired locations by at least a tolerance threshold. The controller 130 then causes the relevant handling robots 111, 113, 150, 152 to reposition the relevant part 120, 122 upon receiving the repositioning signal.

The system controller 130 includes a control logic configured to define a shared coordinate system 138, or shared coordinate frame, between the attached vision sensors located on the movable parts of the robots 111, 113, 150, 152 and the remote vision sensors 128, 134. The shared coordinate system 138 defines the first and second absolute locations and the first and second predetermined desired locations on the shared coordinate system 138. The shared coordinate frame 138 can be created using a single or a plurality of 2D or 3D fiducials.

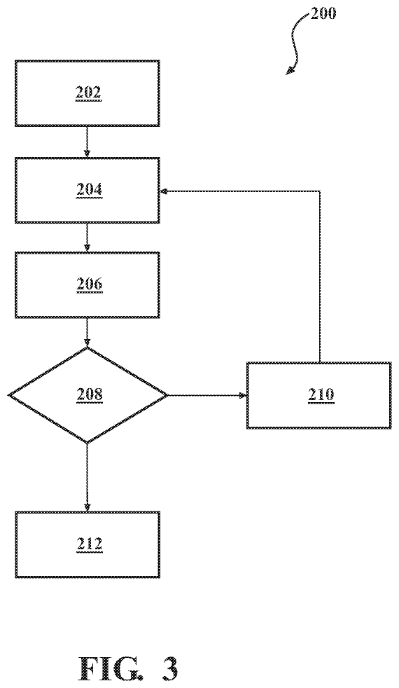

Referring now to FIG. 3, a method of performing a manufacturing operation is illustrated and generally designated at 200. One of the systems 10, 110 described above, along with their controllers 30, 130, may be employed to implement the method 200. The method 200 includes a step 202 of moving a part to a relative position via an end effector on a robot arm based on a local vision signal generated by a local vision sensor located on the end effector. The method 200 then includes a step 204 of sensing an absolute location of the part and/or the end effector via at least one remote vision sensor of a remote vision system located apart from the robot arm and the end effector. The method 206 includes a step 206 of generating a remote vision signal representative of the absolute location. The method further includes a step 208 of comparing the absolute location with a predetermined desired location of the part and/or the end effector. The method 200 includes a step 210 of repositioning the end effector and the part to the predetermined desired location if the absolute location varies from the predetermined desired location by at least a threshold.

After the part is repositioned, the method 200 proceeds back to step 204 in an iterative manner to determine the new absolute location of the end effector and/or the part, and determine whether that absolute location is within the threshold tolerance of the predetermined desired position in step 208. If the end effector and part do not need repositioning in step 210 because the absolute position does not vary from the desired position by at least the threshold tolerance, the method 200 proceeds to a step 212 of performing an operation on the part when absolute location is within the threshold of the predetermined desired location.

The method 200 may implement additional features, such as sensing a part feature, such as a datum feature, on the part via a remote part vision system after the step of performing the operation, and determining a part location based on the part feature. This would serve as a double-check that the operation was performed with the parts in the correct, desired locations. As described above, the part feature may be sensed using laser radar.

In order to properly compare the absolute location of the end effectors or parts with the desired locations thereof, the method 200 may include defining a shared coordinate system for comparing the relative position of the part, the absolute location of the end effector, the predetermined desired location of the end effector, and the part location.

Though the method 200 is described as including one part, it should be understood that method 200 may be performed using multiple robots and multiple parts, such as described in the systems 10, 110 above. For example, the method 200 may include moving a second part to a second relative position via a second end effector on a second robot arm based on a local vision signal generated by a local vision sensor located on the second end effector; sensing a second absolute location of the second end effector via the at least one remote vision sensor, the at least one remote vision sensor being located apart from the second robot arm and the second end effector; generating a second remote vision signal representative of the second absolute location; comparing the second absolute location with a second predetermined desired location of the second end effector; and repositioning the second end effector and the second part if the second absolute location varies from the second predetermined desired location by at least a second threshold until the second absolute location is within the threshold of the predetermined desired location. The step of performing the operation on the first part includes performing a welding operation on the first and second parts to join the first and second parts together.

To perform the joining operation in step 212, the method 200 may include holding the first and second parts in contact with one another while performing the welding or other joining operation. The method 200 may also include sensing a force between the first part and the second part to assist in moving the first part to the first relative position. The method 200 may further include scanning the datum features on the parts prior to the step 202 of moving the part(s) to the relative positions to determine an initial position of the parts for further accuracy.

The method 200 may also include recording positional errors of the first and second end effectors, and using the positional errors to learn first and second robot errors to reduce iterations required to move the first and second end effectors within the threshold. In this way, the errors in the robot movement commands may be learned and incorporated into the repositioning signals to reduce the number of iterations required to move the robots to the correct positions.

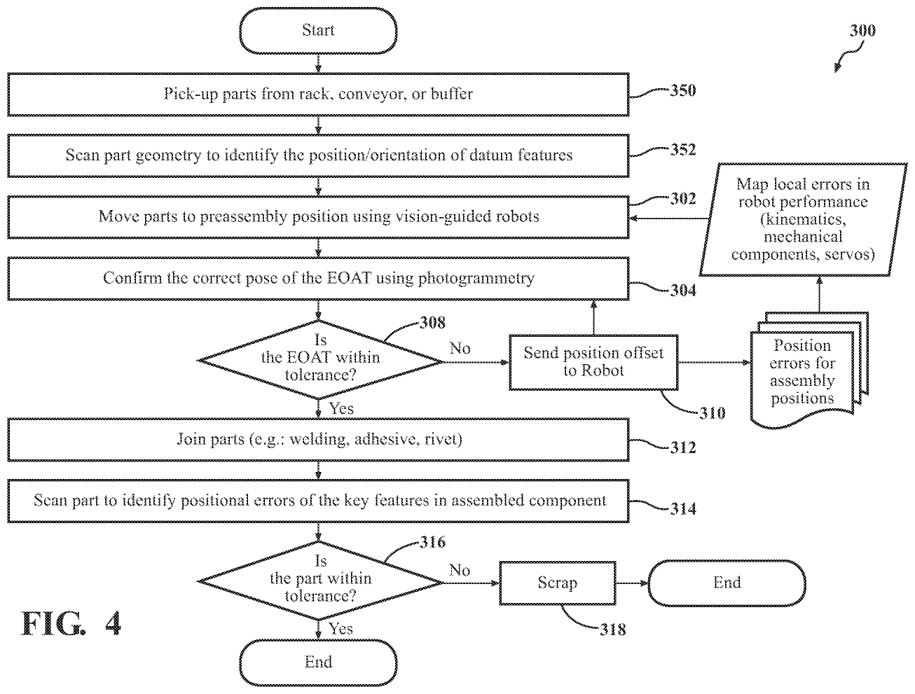

Referring now to FIG. 4, a variation of a method 300 for assembling or manufacturing is illustrated. The method 300 includes a step 350 of picking up parts from a rack, conveyor, or buffer. The method 300 then includes a step 352 of scanning part geometry to identify the position/orientation of the datum features. For example, the scanning can be accomplished via laser radar sensors 34, 134. The method 300 then includes a step 302 of moving the parts to a relative position (or preassembly position) using vision-guided robots, such as the robots having local vision sensors on their end effectors or arms.

The method 300 includes a step 306 of confirming the correct position of the end effectors using remote vision sensors that make up a photogrammetry system, such as the remote sensors 28, 128 described above. The method 300 includes a step 308 of determining whether the end effector is within the tolerance of the correct position. If so, the method proceeds to step 312. If not, a reposition signal is sent to the robot(s) to correct the position of the end effectors prior to joining the parts in step 310, and then the method proceeds to step 306 to confirm the position again and to step 308 to compare its accuracy again. After the end effector is confirmed to be in the correct position, the method proceeds to step 312.

In step 312, the parts are joined, such as through a type of welding, riveting, or adhesive joining. The method 300 may then proceed to a step 314, where the locations of the part locations are checked via a metrology system, such as system 132 that laser scans the datum features, or other part features, on the parts. The method 300 may then proceed to a step 316, where the method 300 determines whether the part locations are within the desired locations within a tolerance. If so, the method ends, and the assembled parts are further utilized. If not, the method 300 may include a step 318 of scrapping, recycling, or repurposing the assembled parts.

In some variations, the location of the operation robot 24, 124, 125 may be determined by the remote vision systems 26, 126 described herein and controlled via a controller based on its absolute location. As described above, the operation robots 24, 124, 125 may include a tool for performing an operation on one or more parts, such as welding, riveting, dispensing glue, or any other manufacturing operation. Accordingly, even in systems that do not use the handling robots described herein, the remote vision system 26, 126 may detect the absolute location of the operation robot 24, 124, 125 or their tools for performing the operation. The remote vision system 26, 126 is located apart from the operation robot 24, 124, 125 and its tool(s). As described above, the remote vision system 26, 126 has at least one vision sensor (such as the remote cameras or laser radar sensors described above) configured to sense an absolute location of the tool and/or other part of the operation robot 24, 124, 125 and to generate a vision signal representative of the absolute location.

The controller is configured to collect the vision signal, and the controller is configured to compare the absolute location with a predetermined desired location of the tool, as described above with respect to the handling robots. The controller is configured to send a repositioning signal to the operation robot 24, 124, 125 if the absolute location varies from the predetermined desired location by at least a predetermined threshold, and the operation robot 24, 124, 125 is configured to move the tool upon receiving the repositioning signal.

Any other details of the remote vision systems 26, 126 above may be incorporated. In some examples, the operation robot 24, 124, 125 may also include an attached local vision sensor that also helps guide the robot 24, 124, 125 and a shared coordinate system, such as described above, to compare the relative location determined by the local vision system with the absolute location determined by the remote vision system 26, 126. The operation robot 24, 124, 125 may be guided along a path to perform the operation using the remote vision system 26, 126, and in some cases, in combination with the local vision sensor(s) located on the robot 24, 124, 125 itself

The present disclosure contemplates that controllers or control systems 30, 130 may perform the methods 200, 300 disclosed herein. The terms controller, control module, module, control, control unit, processor and similar terms refer to any one or various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component may be capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality.

Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms can include any controller-executable instruction sets including calibrations and look-up tables. Each controller executes control routine(s) to provide desired functions, including monitoring inputs from sensing devices and other networked controllers and executing control and diagnostic instructions to control operation of actuators. Routines may be executed at regular intervals, for example each 100 microseconds during ongoing operation. Alternatively, routines may be executed in response to occurrence of a triggering event.

Communication between controllers, and communication between controllers, actuators and/or sensors may be accomplished using a direct wired link, a networked communication bus link, a wireless link or any another suitable communication link. Communication includes exchanging data signals in any suitable form, including, for example, electrical signals via a conductive medium, electromagnetic signals via air, optical signals via optical waveguides, and the like.

Data signals may include signals representing inputs from sensors, signals representing actuator commands, and communication signals between controllers. The term ‘model’ refers to a processor-based or processor-executable code and associated calibration that simulates a physical existence of a device or a physical process. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

Thus, the present disclosure provides a system and method for monitoring and accurately estimating the position and dimensional quality of parts in space being held by a robot or conveyor before, during, and after assembly using metrology equipment. More particularly, the accurate position of the end effectors holding the parts is estimated using photogrammetry with photoreceivers in the end effectors to define their absolute position and orientation. This information is used to correct and control the pose of the robot for assembly.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A part assembly system comprising:
a first robot having a first end effector configured to grip a first part and to move the first part;
a second robot having a second end effector configured to grip a second part and to move the second part;
a third robot configured to perform an operation on the first and second parts, the first and second robots being configured to hold the first and second parts while the third robot performs the operation;
a remote vision system located apart from the first, second, and third robots, the remote vision system having at least one remote vision sensor configured to sense a first absolute location of at least one of the first part and the first end effector and to generate a first remote vision signal representative of the first absolute location, the at least one remote vision sensor being configured to sense a second absolute location of at least one of the second part and the second end effector and to generate a second remote vision signal representative of the second absolute location; and
a controller configured to collect the first remote vision signal and the second remote vision signal, the controller being further configured to compare the first absolute location with a first predetermined desired location of at least one of the first part and the first end effector, the controller being configured to send a first repositioning signal to the first robot if the first absolute location varies from the first predetermined desired location by at least a first threshold, and the controller being further configured to compare the second absolute location with a second predetermined desired location of at least one of the second part and the second end effector, the controller being configured to send a second repositioning signal to the second robot if the second absolute location varies from the second predetermined desired location by at least a second threshold, the first robot being configured to move the first part upon receiving the first repositioning signal, and the second robot being configured to move the second part upon receiving the second repositioning signal.

2. The part assembly system of claim 1, the remote vision system comprising a remote end effector vision system, the at least one remote vision sensor being part of the remote end effector vision system and including at least one photogrammetry sensor configured to determine the first absolute position and the second absolute position, the first absolute position being a position of the first end effector, and the second absolute position being a position of the second end effector.

3. The part assembly system of claim 2, the remote vision system comprising a remote part vision system configured to determine a part location of each of the first and second parts based on at least one part feature on each of the first and second parts.

4. The part assembly system of claim 3, the remote part vision system including a laser radar sensor configured to determine a position of at least one of the part features.

5. The part assembly system of claim 4, the first robot having a first local vision sensor located on a movable portion of the first robot and configured to sense a relative location of the first part and generate a first robot local vision signal representative of the relative location of the first part, the second robot having a second local vision sensor located on a movable portion of the second robot and configured to sense a relative location of the second part and generate a second robot local vision signal representative of the relative location of the second part.

6. The part assembly system of claim 5, wherein the controller includes a control logic configured to define a shared coordinate system between the first local vision sensor, the second local vision sensor, and the at least one remote vision sensor to define the first and second absolute locations and the first and second predetermined desired locations on the shared coordinate system.

7. The part assembly system of claim 6, the third robot being configured to perform a welding operation on the first and second parts to join the first and second parts together, the first and second end effectors being configured to hold the first and second parts in contact with one another while the third robot performs the welding operation.

8. The part assembly system of claim 4, the first robot further having a first force sensor configured to sense force between the first part and the second part.

9. A method of performing a manufacturing operation, the method comprising:
moving a part to a relative position via an end effector on a robot based on a local vision signal generated by a local vision sensor located on a movable part of the robot;
sensing an absolute location of one of the part and the end effector via at least one remote vision sensor of a remote fixed vision system located apart from the robot and the end effector;
generating a remote vision signal representative of the absolute location;
comparing the absolute location with a predetermined desired location of at least one of the part and the end effector;
repositioning the end effector and the part if the absolute location varies from the predetermined desired location by at least a threshold until the absolute location is within the threshold of the predetermined desired location; and
performing an operation on the part when the absolute location is within the threshold of the predetermined desired location.

10. The method of claim 9, the step of sensing the absolution location of one of the part and the end effector including sensing the absolute location of the end effector.

11. The method of claim 10, further comprising sensing a part feature on the part via a remote part vision system after the step of performing the operation, and determining a part location based on the part feature.

12. The method of claim 11, the step of sensing the part feature including using laser radar to sense the part feature.

13. The method of claim 12, further comprising defining a shared coordinate system for comparing the relative position of the part, the absolute location of the end effector, the predetermined desired location of the end effector, and the part location.

14. The method of claim 13, the part being a first part, the relative position being a first relative position, the end effector being a first end effector, the robot being a first robot, the absolute position being a first absolute position, the remote vision signal being a first remote vision signal, the predetermined desired location being a first predetermined desired location, and the threshold being a first threshold, the method further comprising:
moving a second part to a second relative position via a second end effector on a second robot based on a local vision signal generated by a second local vision sensor located on the second end effector;
sensing a second absolute location of the second end effector via the at least one remote vision sensor, the at least one remote vision sensor being located apart from the second robot and the second end effector;
generating a second remote vision signal representative of the second absolute location;
comparing the second absolute location with a second predetermined desired location of the second end effector; and
repositioning the second end effector and the second part if the second absolute location varies from the second predetermined desired location by at least a second threshold until the absolute location is within the threshold of the predetermined desired location, wherein the step of performing the operation on the first part includes performing a welding operation on the first and second parts to join the first and second parts together.

15. The method of claim 14, further comprising recording positional errors of the first and second end effectors, and using the positional errors to learn first and second robot errors to reduce iterations required to move the first and second end effectors within the thresholds.

16. The method of claim 14, further comprising sensing a force between the first part and the second part to assist in moving the first part to the first relative position.

17. The method of claim 13, wherein the step of sensing the part feature is performed after the step of moving the part to the relative position based on the local vision signal generated by the local vision sensor, the method further comprising scanning the part feature prior to the step of moving the part to the relative position to determine an initial position of the part.

18. A part manufacturing system comprising:
a part-moving robot having an end effector configured to grip a part and to move the part;
an operation robot configured to perform an operation on the part, the part-moving robot being configured to hold the part while the operation robot performs the operation;
a remote vision system located apart from the robots, the remote vision system having at least one remote vision sensor configured to sense an absolute location of at least one of the part and the end effector and to generate a remote vision signal representative of the absolute location; and
a controller configured to collect the remote vision signal, the controller being further configured to compare the absolute location with a predetermined desired location of at least one of the part and the end effector, the controller being configured to send a repositioning signal to the part-moving robot if the absolute location varies from the predetermined desired location by at least a predetermined threshold, the part-moving robot being configured to move the part upon receiving the repositioning signal.

19. The part manufacturing system of claim 18, the remote vision system comprising a remote end effector vision system configured to determine the absolute location, the absolute location being a location of the end effector, the remote vision system further comprising a remote part vision system including a laser radar sensor and being configured to determine a part location of the part based on at least one part feature on the part,
wherein the controller includes a control logic configured to define a shared coordinate system between the vision sensor, the fixed vision sensor, and the laser radar sensor to define the absolute location and the predetermined desired location on the shared coordinate system.

20. A manufacturing system comprising:
an operation robot having a tool configured to perform an operation on a part;
a remote vision system located apart from the operation robot, the remote vision system having at least one vision sensor configured to sense an absolute location of the tool and to generate a vision signal representative of the absolute location; and
a controller configured to collect the vision signal, the controller being further configured to compare the absolute location with a predetermined desired location of the tool, the controller being configured to send a repositioning signal to the operation robot if the absolute location varies from the predetermined desired location by at least a predetermined threshold, the operation robot being configured to move the tool upon receiving the repositioning signal.
